(19) United States
(12) Patent Application Publication
(10) Pub. No.: US 2020/0094853 A1
(43) Pub. Date: Mar. 26, 2020

(54) SYSTEM FOR PROVIDING HAPTIC FEEDBACK IN A WORK VEHICLE

(71) Applicant: CNH Industrial America LLC, New Holland, PA (US)

(72) Inventor: Ivan Tate, Lisle, IL (US)

(73) Assignee: CNH Industrial America LLC

(21) Appl. No.: 16/139,947

(22) Filed: Sep. 24, 2018

(51) Int. Cl. B60W 50/16

(52) U.S. Cl. CPC B60W 50/16; B60W 2300/15

(57) ABSTRACT

A haptic feedback system for a work vehicle includes at least one controller that may control haptic feedback through a steering controller, determine a status change associated with the work vehicle, and output a command indicative of instructions to a haptic feedback actuator configured to provide haptic feedback to the steering controller to indicate the status change.

### BACKGROUND

The present disclosure relates generally to work vehicles (e.g., agricultural vehicles), and more particularly, to a haptic feedback system of a work vehicle.

Work vehicles (e.g., agricultural vehicles) may perform various automated operations in a work area. For example, the work vehicle may automatically lower or raise an attached implement, perform headland maneuvers, etc. These automated operations may reduce the workload of an operator, thereby increasing the efficiency of agricultural operations. Work vehicles may also provide audible and/or visual notifications to the operator upon completion of these automated operations. However, these notifications may be difficult for the operator to discern during operation of the work vehicle.

### BRIEF DESCRIPTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In certain embodiments, a haptic feedback system for a work vehicle includes at least one controller that may control haptic feedback through a steering controller, determine a status change associated with the work vehicle, and output a command indicative of instructions to a haptic feedback actuator configured to provide haptic feedback to the steering controller to indicate the status change.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an agricultural implement and a work vehicle;

FIG. 2 is a schematic view of an embodiment of a steering system that may be employed within the work vehicle of FIG. 1;

FIG. 3 is a front view of an embodiment of a steering wheel that may be employed within the steering system of FIG. 2; and

FIG. 4 is a side view of an embodiment of a steering wheel that may be employed within the steering system of FIG. 2.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

Various embodiments of the present disclosure include a haptic feedback system of a work vehicle (e.g., an agricultural vehicle). Automated operations of a work vehicle often reduce the workload of an operator of the work vehicle, thereby increasing the efficiency of agricultural operations. Traditional work vehicles may provide the operator with audible notifications and/or visual notifications that the automated operations have completed. However, during operation of the work vehicle, the audible environment and the visual environment of the operator may make it difficult for an operator to discern such notifications. For example, the noise from the operation of the work vehicle may suppress the sound of an audible notification from the work vehicle, and/or an operator may be unable to clearly see a visual notification on a display in the work vehicle due to sunlight interference. Additionally, an operator may not see visual notifications while looking away from a screen displaying the visual notifications.

As discussed in detail below, the work vehicle may provide haptic feedback to the operator through the steering wheel of the work vehicle to indicate a change in status of the work vehicle and/or an agricultural implement coupled to the work vehicle. For example, a haptic feedback controller of the work vehicle may output a command (e.g., a signal) to an electric power assisted steering (EPAS) controller of the work vehicle to provide haptic feedback to the steering wheel of the work vehicle. The haptic feedback may include a vibration or a series of vibrations that the operator may feel through the steering wheel. Based on the particular haptic feedback provided through the steering wheel, the operator may discern when a work vehicle has completed an automated operation, or when the work vehicle has changed between different operations or between different stages of an operation. For example, the haptic feedback controller of the work vehicle may convey to an operator that the hitch of the work vehicle and/or a coupled agricultural implement has been raised to a predetermined or target position, or lowered to a predetermined or target position by providing haptic feedback through the steering wheel. In another example, the haptic feedback controller of the work vehicle may convey to the operator completion of each step in a headland maneuver by providing haptic feedback through the steering wheel after each completed step. Additionally, the haptic feedback controller of the work vehicle may convey other types of information to the operator through haptic feedback in the steering wheel. For example, the haptic feedback controller of the work vehicle may convey to the operator performance information associated with the work vehicle and/or the agricultural implement coupled to the work vehicle, location and/or positional information associated with the work vehicle, engine information, and/or the like. Further, the EPAS controller may provide haptic feedback to the steering wheel by causing the steering wheel to vibrate in a left and right direction, a forward and backward direction, or both. Because the steering wheel provides haptic feedback to the operator, environmental interference, such as light and noise, with receiving the operational, performance, location, and/or positional information of the work vehicle is substantially reduced or eliminated. Additionally, providing haptic feedback to the operator through the steering wheel enables the operator to focus on the path of the vehicle rather than reviewing visual notifications on a screen.

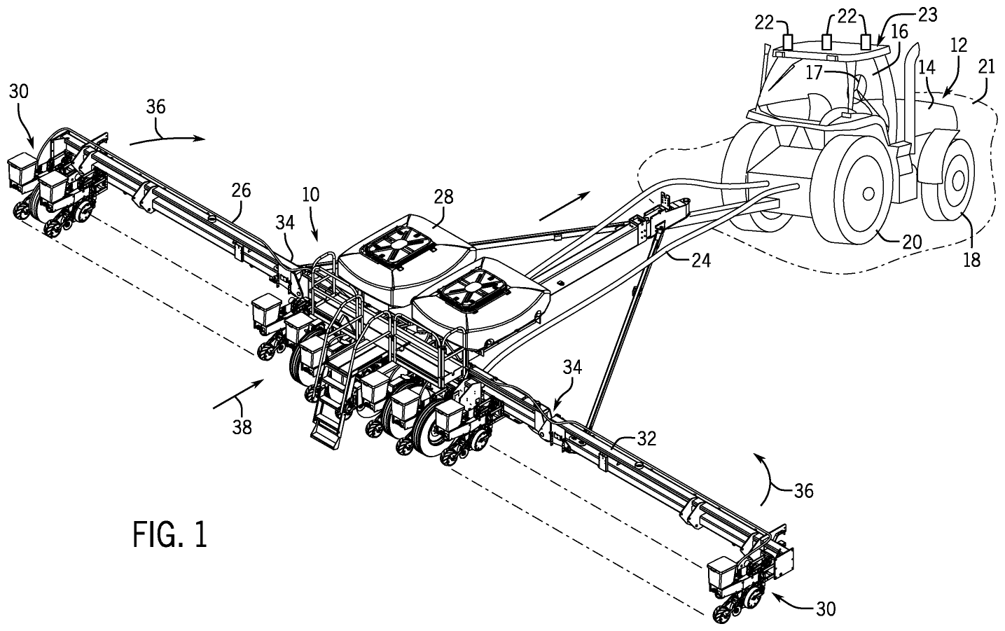

Turning now to the drawings, FIG. 1 is a perspective view of an embodiment of an agricultural implement 10 and a work vehicle 12 (e.g., agricultural vehicle or tractor). The illustrated work vehicle 12 has a body 14 that houses an engine, a transmission (e.g., gear box), a braking system, a steering system, a four-wheel drive (4WD)/differential lock system, a power train, or a combination thereof. The work vehicle 12 has a cabin 16 where an operator may sit or stand to manually operate the vehicle 12 using, for example, a steering wheel 17. The work vehicle 12 has two front wheels 18 and two rear wheels 20 that rotate to move the work vehicle 12 along the ground 21 (e.g., a field). In some embodiments, the work vehicle 12 may have tracks rather than one or both sets of wheels 18, 20.

As shown in the illustrated embodiment, the work vehicle 12 includes sensors 22 that may be utilized to monitor conditions of the ground 21 (e.g., a field). For example, the sensors 22 are mounted on a roof 23 of the work vehicle 12 such that the sensors 22 may be free from obstruction caused by other components of the work vehicle 12 (e.g., a frame of the cabin 16 or windows of the work vehicle). However, the sensors 22 may be positioned in any suitable location on the work vehicle 12 such that the sensors 22 may accurately monitor and provide feedback regarding the surrounding environment to a control system of the work vehicle 12. In certain embodiments, the sensors 22 may include light detecting and ranging (LIDAR) sensors, radio detection and ranging (RADAR) sensors, stereo-vision sensors, cameras (e.g., video cameras), 3-dimensional time of flight sensors, bumper sensors, infrared cameras (e.g., infrared video cameras), or any combination thereof. In other embodiments, the sensors 22 may include any other suitable type of sensor configured to monitor conditions of the environment surrounding the work vehicle 12 and provide feedback to a control system of the work vehicle. In some embodiments, the sensors 22 may include a location sensor, such as a GPS receiver. The location sensor may provide location and/or positional information to the control system of the work vehicle 12.

The sensors 22 are configured to output feedback to the control system that may then perform operations based on such feedback. For example, the control system may include a sub-system that performs simultaneous location and mapping (SLAM), obstacle detection, object recognition, contextual reasoning, and/or another form of decision making. As a non-limiting example, a LIDAR sensor may detect an object along the ground 21 and send feedback to the control system regarding how far the object is from the work vehicle 12.

The agricultural implement 10 is coupled to a hitch 25 of the work vehicle 12 and is towed behind the work vehicle 12 across the ground 21 (e.g., in direction 38 of travel), as shown in FIG. 1. In some embodiments, the agricultural implement 10 may be incorporated into the work vehicle 12. Additionally, the agricultural implement 10 may be any suitable implement for agricultural use such as, but not limited to, a ground-engaging implement (e.g., a soil conditioner, a tillage implement, a fertilizer application implement, a planter, a seeder, etc.) or a sprayer/applicator. The work vehicle 12 may supply a working fluid (e.g., hydraulic fluid) to the agricultural implement 10 via one or more fluid lines 24. One or more actuators (e.g., hydraulic motors, hydraulic cylinders, etc.) on the agricultural implement may receive the working fluid from the work vehicle 12 to drive systems of the agricultural implement 10. For example, one or more hydraulic motors may drive a fan and/or seed drive to direct agricultural material (e.g., seeds, fertilizer, etc.) along supply lines 26 from tanks 28 to multiple row units 30 distributed along a frame assembly 32. Each row unit 30 may be configured to deposit seeds at a desired depth beneath the soil surface, thereby establishing rows of planted seeds.

The agricultural implement 10 may have a variety of systems driven by the working fluid (e.g., hydraulic fluid) supplied by the work vehicle 12. For example, motors of the agricultural implement 10 may be driven by the working fluid to facilitate delivery of the agricultural product and/or to establish a pressure within the tanks 28 or supply lines. In some embodiments, the frame assembly 32 of the agricultural implement 10 may be adjustable to fold into a transport configuration (e.g., via rotation of wings about joints 34) as shown by arrows 36. Accordingly, the frame assembly 32 may be adjusted by controlling an actuator on the agricultural implement to fold the wings.

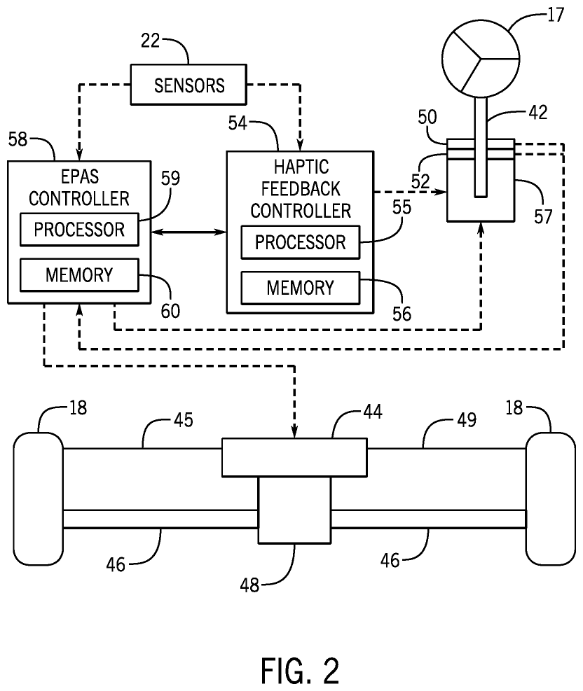

FIG. 2 is a schematic view of an embodiment of an electric power assisted steering (EPAS) system 40 that may be employed within the work vehicle of FIG. 1. As described above, the work vehicle may be manually operated using a steering wheel 17 that causes the front wheels 18 to turn to control the direction and/or movement of the work vehicle. In certain embodiments, the work vehicle may be operated using a hand controller or any other suitable steering controller configured to contact a part of an operator's body and facilitates controlling the direction and/or movement of the work vehicle.

The steering wheel 17 is mechanically coupled to a steering column 42 such that a steering wheel input of the operator of the work vehicle provides a motion and/or torque to the steering column 42. A steering position sensor 50 is provided to monitor or detect one or more steering angle-related parameters based on a motion of the steering column 42 from a steering wheel input of the operator of the work vehicle. The steering angle sensor 50 may include an analog steering sensor, a digital or contactless steering sensor, or any other suitable sensor capable of measuring a steering-angle related parameter based on the steering wheel input of the operator. In certain embodiments, two or more steering position sensors 50 may be provided to monitor or detect the one or more steering angle-related parameters based on the motion of the steering column 42. A torque sensor 52 is provided to monitor or detect a torque of the steering column 42 applied via the steering wheel input of the operator of the work vehicle. The torque sensor 52 may include a contact torque sensor, a non-contact torque sensor, or any other suitable torque sensor that is capable of determining an amount of steering torque applied based on the steering input of the driver. The steering position sensor 50 and the torque sensor 52 provide feedback to an EPAS controller 58 which may instruct a steering actuator 44 to apply a corresponding steering angle via steering linkages 45, 49 to the front wheels 18. Additionally, the EPAS controller 58 may instruct differential 48 to transmit torque to axels 46 which are each coupled to a respective front wheel 18. As such, the front wheels 18 may be steered by rotating the steering wheel 17. In certain embodiments, other sensors may also provide signal inputs to the EPAS controller 42 such as vehicle dynamics sensors (e.g., speed, acceleration, wheel spin/slip, etc.) or any other suitable types of sensors.

A haptic feedback controller 58 is also operatively coupled to the EPAS controller 54. In certain embodiments, the haptic feedback controller 58 and the EPAS controller 54 may be the same device. Both the haptic feedback controller 58 and the EPAS controller 54 have electronic circuitry configured to process data from the sensors 22, the steering angle sensor 50, and the torque sensor 52, and operate particular components of the EPAS system 40. In the illustrated embodiment, the EPAS controller 54 includes a processor 55 and a memory device 56, and haptic feedback controller 58 includes a processor 59 and a memory device 60. The processors 55, 59 may be used to execute software, such as software for providing commands and/or data to the EPAS controller 54 and the haptic feedback controller 58, respectively, and so forth. Moreover, the processors 55, 59 may include multiple microprocessors, one or more “general-purpose” microprocessors, one or more special-purpose microprocessors, and/or one or more application specific integrated circuits (ASICS), or some combination thereof. For example, the processors 55, 59 may include one or more reduced instruction set (RISC) processors. The memory devices 56, 60 may include a volatile memory, such as random access memory (RAM), and/or a nonvolatile memory, such as read-only memory (ROM). The memory devices 56, 60 may store a variety of information and may be used for various purposes. For example, the memory devices 56, 60 may store processor-executable instructions (e.g., firmware or software) for the respective processors 55, 59 to execute, such as instructions for providing commands and/or data to a haptic feedback actuator 57 communicatively coupled to the EPAS controller 58 and/or the haptic feedback controller 54.

Upon determining that haptic feedback should be conveyed to the operator of the work vehicle through the steering wheel 17, the haptic feedback controller 58 outputs a command (e.g., a signal) to the EPAS controller 54 to instruct the haptic feedback actuator 57 to provide haptic feedback to the steering wheel 17. For example, the haptic feedback actuator 57 may apply a varying torque and/or a linear force to the steering column 42 and/or the steering wheel 17 such that a vibration or a series of vibrations are provided to the operator of the work vehicle via the steering wheel 17.

The haptic feedback actuator 57 may be any suitable actuator for providing haptic feedback to the steering wheel 17. In certain embodiments, the haptic feedback actuator 57 may be a solenoid valve or any other electromechanical device. The haptic feedback actuator 57 is mechanically coupled to the steering column 42 and/or the steering wheel 17 such that the haptic feedback actuator 57 is configured to provide haptic feedback via the steering wheel 17 to the operator of the work vehicle 12. Although the haptic feedback actuator 57 is coupled to the steering column 42 in FIG. 2, the haptic feedback actuator 57 may be coupled to any suitable component of the EPAS system 40 to provide haptic feedback via the steering wheel 17 to the operator of the work vehicle. For example, the haptic feedback actuator 57 may be coupled directly to the steering wheel 17 to provide a vibration or a series of vibrations directly to the steering wheel 17. In certain embodiments, more than one haptic feedback actuator 57 may be operably coupled to the haptic feedback controller 57 and mechanically coupled to the steering column 42 and/or the steering wheel 17.

In some embodiments, upon determining that haptic feedback should be conveyed to the operator of the work vehicle through the steering wheel 17, the haptic feedback controller 58 may output a command to the haptic actuator 57 or may output a command to the EPAS controller 58 to provide a command to the haptic actuator 57 to provide haptic feedback to the steering wheel 17.

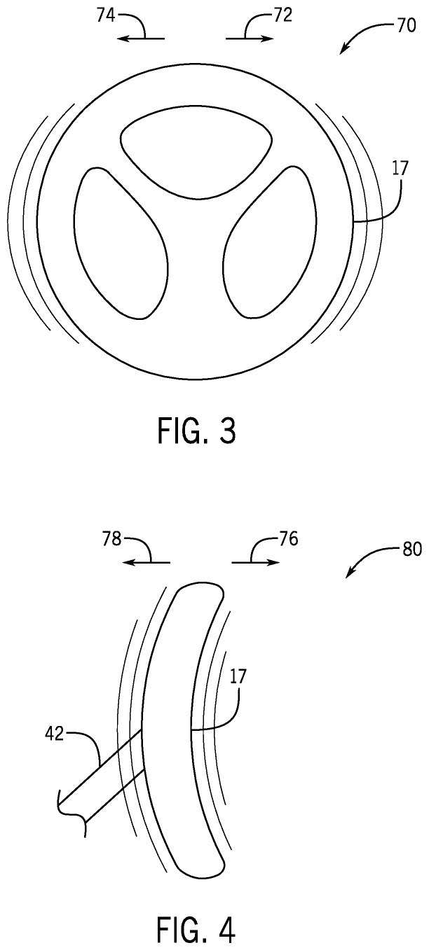

FIG. 3 is a front view 70 of an embodiment of a steering wheel 17 that may be employed within the EPAS system 40 of FIG. 2. In the depicted embodiment, the EPAS controller instructs the haptic feedback actuator to provide vibrations to the steering wheel 17 in a left direction 74 and a right direction 72 with respect to the original position of the steering wheel 17. For example, the EPAS controller may instruct the haptic feedback actuator to apply a torque to the steering column 42 and the steering wheel 17 in the left direction 74 and the right direction 72 in an alternating pattern. FIG. 4 is a side view 80 of an embodiment of a steering wheel 17 that may be employed within the EPAS system 40 of FIG. 2. In the depicted embodiment, the EPAS controller 54 instructs the haptic feedback actuator to provide vibrations the steering wheel 17 in a forward direction 78 away from the operator and a backward direction 76 toward the operator. For example, the EPAS controller 54 may instruct the haptic feedback actuator to provide a linear force to the steering column 42 to push and pull the steering column 42 and the steering wheel 17 in the forward direction 78 and the backward direction 76 in an alternating pattern.

As described above, the haptic feedback may include a vibration or a series of vibrations in the steering wheel 17. For example, the EPAS controller may instruct the haptic feedback actuator to provide one vibration, two vibrations, three vibrations, four vibrations, five vibrations, or more vibrations, to the steering wheel 17. In some embodiments, the EPAS controller may instruct the haptic feedback actuator to provide a series of vibrations in alternating directions. For example, a series of two vibrations may include a first vibration in the left 74 and right 72 direction and second vibration in the forward 78 and backward 76 direction. In another example, a series of three vibrations may include a first vibration in the forward 78 and backward 76 direction, a second vibration in the left 74 and right 72 direction, and a third vibration in the forward 78 and backward 76 direction. In other embodiments, the haptic actuator 57 may provide a series of vibrations in the same direction. For example, a series of two vibrations may both be in the left 74 and right 72 direction. In another example, a series of three vibrations may all be in the forward 78 and backward 76 direction. In some embodiments, the series of vibrations may include any combination of vibration(s) in the left 74 and right 72 direction and/or vibration(s) in the forward 78 and backward 76 direction. Additionally, each vibration may have the same duration or different durations. For example, each vibration may last half a second, one second, two one and a half seconds, two seconds, or any suitable duration to facilitate discernment by the operator of the individual vibrations. Each vibration may also vary in duration of movement in a direction, torque in a direction, frequency in a direction, or the like. Further, each vibration in a series of vibrations may be separated by a pause from each subsequent vibration. For example, the pause between subsequent vibrations may be of a duration equal to a quarter of a second, a half of a second, three-quarters of a second, one second, one and a half seconds, two seconds, or any suitable duration to facilitate discernment by the operator of the individual, consecutive vibrations in the steering wheel 17. In certain embodiments, the number of vibrations, the duration of each individual vibration, the duration between individual vibrations in a series of vibrations, or a combination thereof, may be unique for each configuration of haptic feedback provided to the steering wheel 17 to indicate a status change or other information associated with the work vehicle, the hitch and/or the agricultural implement, the environment surrounding the work vehicle, or any combination thereof.

The haptic feedback controller may output a command to the EPAS controller to provide haptic feedback to the steering wheel 17 to indicate a status change associated with the work vehicle and/or the agricultural implement coupled to the work vehicle. In certain embodiments, the haptic feedback controller may output a command to the EPAS controller to instruct the haptic feedback actuator to provide haptic feedback to the steering wheel 17 to indicate that the work vehicle has completed an automated operation. For example, after the hitch of the work vehicle, an agricultural implement coupled to the work vehicle, or both, have been raised or lowered to a predetermined or target position, the haptic feedback controller may output a command to the EPAS controller 54 to provide haptic feedback to the steering wheel 17 to notify the operator that the hitch, the agricultural implement, or both, have been raised or lowered to the predetermined or target position. In some embodiments, the haptic feedback provided to the steering wheel 17 corresponding to the hitch, the agricultural implement, or both, being raised to a predetermined or target position may be different than the haptic feedback provided to the steering wheel 17 corresponding to the hitch, the agricultural implement, or both, being lowered to a predetermined or target position. For example, the EPAS controller 54 may instruct the haptic feedback actuator to provide a forward 78 and backward 76 directional vibration in the steering wheel 17 in response to the hitch and/or the agricultural implement being raised to a predetermined or target position, and the EPAS controller may instruct the haptic feedback actuator to provide a left 74 and right 72 directional vibration in the steering wheel 17 in response to the hitch and/or the agricultural implement being lowered to the predetermined or target position. In another example, the EPAS controller may instruct the haptic feedback actuator to provide a single vibration in the steering wheel 17 in response to the hitch and/or the agricultural implement being raised to a predetermined or target position, and the EPAS controller may instruct the haptic feedback actuator to provide a series of two vibrations in response to the hitch and/or the agricultural implement being lowered to a predetermined or target position.

In certain embodiments, the haptic feedback controller may output a command to the EPAS controller to instruct the haptic feedback actuator to provide haptic feedback to the steering wheel 17 to indicate that the work vehicle 12 has automatically changed between different modes of operation or between different stages of an operation. For example, the EPAS controller may instruct the haptic feedback actuator to provide haptic feedback to the steering wheel 17 to indicate the initiation and/or the completion of each step in a headland maneuver automatically performed by the work vehicle at the end of a first row in a field to move to a second row in the field. In some embodiments, the steps of a headland maneuver include (1) detecting the end of a first row in a field, (2) raising the hitch and/or agricultural implement, (3) turning into the headland of the field, (4) turning into a second row in the field, and (5) lowering the hitch and/or agricultural implement. The EPAS controller may instruct the haptic feedback actuator to provide the same type of haptic feedback upon the initiation and/or the completion of each individual step in a headland maneuver performed by the work vehicle. For example, the EPAS controller may instruct the haptic feedback actuator to provide a single vibration to the steering wheel 17 to indicate the initiation and/or the completion of each step in the headland maneuver performed by the work vehicle. Alternatively, the EPAS controller 54 may instruct the haptic feedback actuator to provide different types of haptic feedback to the steering wheel 17 corresponding to the initiation and the completion of each individual step in a headland maneuver performed by the work vehicle 12. For example, the EPAS controller may instruct the haptic feedback actuator to provide a single vibration to the steering wheel 17 to indicate the initiation of each step and a series of two vibrations to indicate the completion of each step. In certain embodiments, the EPAS controller may instruct the haptic feedback actuator to provide unique haptic feedback to the steering wheel 17 corresponding to each individual step in a headland maneuver performed by the work vehicle. For example, the EPAS controller may instruct the haptic feedback actuator to provide a single vibration to the steering wheel 17 upon determination that the work vehicle reached the end of a first row in the field, provide a series of two vibrations to the steering wheel 17 upon determination that the hitch and/or agricultural implement has been raised to a predetermined or target position, provide a series of three vibrations to the steering wheel 17 upon determination that the work vehicle has turned into the headland of the field, provide a series of four vibrations to the steering wheel 17 upon determination that the work vehicle has turned into a second row in the field, and provide a series of five vibrations to the steering wheel 17 upon determination that the hitch and/or agricultural implement has been lowered to the predetermined or target position. Although embodiments of a headland maneuver performed by the work vehicle are described herein with five steps, the headland maneuver may include any suitable number of individual steps performed by the work vehicle. Accordingly, the EPAS controller may instruct the haptic feedback actuator to provide haptic feedback corresponding to the initiation and/or completion of each of these steps.

In certain embodiments, the haptic feedback controller may output a command to the EPAS controller to instruct the haptic feedback actuator to provide haptic feedback to the steering wheel 17 of the work vehicle when the work vehicle is ready to switch between manual operation and automated operation. For example, the haptic feedback controller may instruct the haptic feedback actuator to provide a vibration or a series of vibrations to the steering wheel 17 upon determining that the work vehicle is receiving sufficiently consistent location information (e.g., a GPS signal) to navigate the work vehicle automatically along a predetermined or target path without assistance from the operator.

Additionally or alternatively, the haptic feedback controller may output a command to the EPAS controller to instruct the haptic feedback actuator to provide haptic feedback to the steering wheel 17 to indicate information associated with the work vehicle, the agricultural implement, and/or the environment surrounding the work vehicle to the operator. For example, the EPAS controller may instruct the haptic feedback actuator to provide feedback to the steering wheel 17 to indicate operational status information associated with the work vehicle or an agricultural implement coupled to the work vehicle, location and/or positional information associated with the work vehicle, engine information associated with the work vehicle, and/or changes thereof. In another example, the EPAS controller may receive feedback from sensors 22 and determine that an object is obstructing the path of the work vehicle based on the feedback from sensors 22. As such, the EPAS controller may instruct the haptic feedback actuator to provide haptic feedback to the steering wheel 17 to indicate to the operator that an obstruction is in the path of the work vehicle.

In certain embodiments, the haptic feedback controller 58 may output a command to the EPAS controller to instruct the haptic feedback actuator to provide haptic feedback to the steering wheel 17 to indicate performance information, or a change thereof, associated with the work vehicle and/or the agricultural implement coupled to the work vehicle. Such performance information may include the rate of application of agricultural product by the agricultural implement. For example, a fertilizer application implement may be coupled to the work vehicle, and the rate of application of the fertilizer may be indicated by a series of vibrations in the steering wheel 17 that correspond to the rate of application. The EPAS controller may also instruct the haptic feedback actuator to provide haptic feedback to the steering wheel 17 when a change in fertilizer application has occurred. Performance information may also detection of reaching the end of a row in a field. For example, the EPAS controller may instruct the haptic feedback actuator to provide a vibration or a series of vibrations to the steering wheel 17 to indicate that the work vehicle is approaching the end of the row. In certain embodiments, the rate of vibrations provided to the steering wheel 17 may increase as the work vehicle approaches the end of the row. For example, the spacing between a series of two vibrations may decrease as the work vehicle approaches the end of the row.

In certain embodiments, the haptic feedback controller may output a command to the EPAS controller 54 to instruct the haptic feedback actuator to provide haptic feedback to the steering wheel 17 to indicate location and/or positional information, or a change thereof, associated with the work vehicle. Such location and/or positional information may include a departure of the work vehicle 12 from a predetermined or target path through a field. For example, the haptic feedback controller may output a command to the EPAS controller to instruct the haptic feedback actuator to provide a vibration or series of vibrations to the steering wheel 17 to indicate that work vehicle has strayed from a predetermined or target path based on GPS data associated with the work vehicle.

In certain embodiments, the haptic feedback controller may output a command to the EPAS controller to instruct the haptic feedback actuator to provide haptic feedback to the steering wheel 17 to indicate engine status information, or a change thereof, associated with the work vehicle. Such engine status information may include information associated with engine performance, wheel slippage, coolant temperature, oil pressure, the brake system, the transmission, or the battery.

While only certain features and embodiments have been illustrated and described, many modifications and changes may occur to those skilled in the art. It is, therefore, to be understood that the appended claims are intended to cover all such modifications and changes as fall within the true spirit of the disclosure.

The techniques presented and claimed herein are referenced applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any elements containing elements designated in any other manner, it is intended that such elements are not to be interpreted under 35 U.S.C. 112(f).

1. A haptic feedback system for a work vehicle, comprising:
at least one controller configured to:
control haptic feedback through a steering controller;
determine a status change associated with the work vehicle; and
output a command indicative of instructions to a haptic feedback actuator configured to provide haptic feedback to the steering controller to indicate the status change.

2. The haptic feedback system of claim 1, comprising two controllers, wherein:
a first controller of the two controllers is configured to control haptic feedback through the steering controller; and
a second controller of the two controllers is configured to determine the status change associated with the work vehicle and output the command indicative of instructions to the haptic feedback actuator to provide haptic feedback to the steering controller to indicate the status change.

3. The haptic feedback system of claim 1, wherein the status change associated with the work vehicle comprises a completion of an automated operation.

4. The haptic feedback system of claim 3, wherein the automated operation comprises raising a hitch of the work vehicle to a first target raised position, raising an agricultural implement operably coupled to the work vehicle to a second target raised position, or both.

5. The haptic feedback system of claim 3, wherein the automated operation comprises lowering a hitch of the work vehicle to a first target lowered position, lowering an agricultural implement operably coupled to the work vehicle to a second target lowered position, or both.

6. The haptic feedback system of claim 1, wherein the status change associated with the work vehicle comprises a transition of the work vehicle from a first operational stage of a headland maneuver to a second operational stage of the headland maneuver.

7. The haptic feedback system of claim 6, wherein the instructions indicative of the haptic feedback comprises instructions to provide a first vibration upon the completion of the first operational stage and a second vibration upon the initiation of the second operation stage.

8. The haptic feedback system of claim 1, wherein the status change associated with the work vehicle comprises a change in a rate of application of an agricultural product from an agricultural implement operably coupled to the work vehicle.

9. The haptic feedback system of claim 1, wherein the steering controller comprises a steering wheel or a hand controller.

10. A haptic feedback system for a work vehicle, comprising:
a steering controller mechanically coupled to a steering column;
a haptic feedback actuator coupled to the steering column; and
an electric power assisted steering (EPAS) controller communicatively coupled to the haptic feedback actuator, wherein the EPAS controller is configured to output a command to the haptic feedback actuator indicative of instructions to provide haptic feedback to the steering wheel, and the haptic feedback comprises a vibration in a forward direction and a backward direction along the longitudinal axis of the steering column.

11. The haptic feedback system of claim 10, wherein the haptic feedback actuator comprises a solenoid valve.

12. The haptic feedback system of claim 10, wherein the haptic feedback actuator is configured to apply a linear force to the steering column to provide the vibration in the forward direction and the backward direction along a longitudinal axis of the steering column.

13. The haptic feedback system of claim 10, wherein the vibration is a first vibration and the haptic feedback actuator is configured to apply torque to the steering column to provide a second vibration in a left direction and a right direction along transverse axis of the steering column.

14. The haptic feedback system of claim 13, wherein the first vibration and the second vibration have the same vibrational duration.

15. The haptic feedback system of claim 10, wherein the EPAS controller is configured to determine a status change associated with the work vehicle and output the command to the haptic feedback actuator based on the determined status change.

16. The haptic feedback system of claim 15, wherein the status change associated with the work vehicle comprises a transition of the work vehicle from a first operational stage of a headland maneuver to a second operational stage of the headland maneuver.

17. A haptic feedback system for an agricultural vehicle having a steering wheel, comprising:
at least one controller configured to:
control haptic feedback through a steering controller;
determine a status change associated with the work vehicle; and
output a command indicative of instructions to a haptic feedback actuator provide haptic feedback to the steering controller to indicate the status change, wherein the haptic feedback comprises a vibration in a forward direction and a backward direction along the longitudinal axis of the steering column.

18. The haptic feedback system of claim 17, wherein the status change associated with the work vehicle comprises a transition of the work vehicle from a first operational stage of a headland maneuver to a second operational stage of the headland maneuver.

19. The haptic feedback system of claim 18, wherein the instructions indicative of the haptic feedback comprises instructions to provide a first vibration upon the completion of the first operational stage and a second vibration upon the initiation of the second operation stage.

20. The haptic feedback system of claim 19, wherein the first vibration and the second vibration have different respective vibrational durations.
